(19) United States
(12) Patent Application Publication
(10) Pub. No.: US 2003/0076376 A1
(43) Pub. Date: Apr. 24, 2003

(54) Inkjet printhead with integrated sealing and wiping function

(76) Inventors: John C. Greeven, Corvallis, OR (US); James P. Kearns, Corvallis, OR (US); David M. Wetchler, Vancouver, WA (US); Louis C. Barinaga, Salem, OR (US)

Correspondence Address: HEWLETT-PACKARD COMPANY, Intellectual Property Administration, P.O. Box 272400, Fort Collins, CO, 80527-2400, US

(21) Appl. No.: 10/001,559

(22) Filed: Oct. 23, 2001

(51) Int. Cl. B41J 2/165

(52) U.S. Cl. 347/29; 347/32; 347/33

(57) ABSTRACT

An inkjet printhead with an integrated sealing and wiping function is disclosed. A printhead body is provided with at least one nozzle opening. A shutter member movably engages the printhead, and an actuator moves the shutter member between an open position and a closed position. When in the open position, the shutter member exposes the nozzle opening, allowing the printhead to deposit ink onto a printing medium such as paper. When the printhead is not printing or is in a maintenance mode, the actuator moves the shutter member to the closed position. During the movement, the shutter member performs a wiping function on the nozzle opening. Once the shutter member has been moved to the closed position, it acts to cap, or seal, the nozzle opening from the outside environment.

### FIELD OF THE INVENTION

The invention relates to inkjet printing mechanisms. In particular, the invention relates to inkjet printing mechanism with integrated sealing and wiping function.

### BACKGROUND

Typical operation of an inkjet printer involves the movement of a printhead which may be mounted on a printhead carriage. The printhead traverses the printer along an axis that is generally perpendicular to the direction of the movement of a printing medium such as paper. The printhead is provided with nozzles through which ink is deposited onto the printing medium. Each printhead may have several nozzles, each corresponding to a different color ink.

In operation, as the printhead traverses the width of the printing medium, it selectively deposits ink upon the printing medium. The printing medium is then advanced and another section of the printing medium may be deposited with ink. Through repetition of this process, the entire printing medium is exposed to the printhead and the appropriate image is printed upon the printing medium.

In a typical inkjet printer, a “service station” may be provided for cleaning and maintenance of the printhead. The service station is typically provided in a section of the printer through which the printing medium does not pass (e.g., on one edge of the printer chassis). Thus, the printhead may be moved to the service station area when the printhead is not performing a printing operation. Service stations typically perform several functions, including wiping of the nozzles exists and capping the nozzles when not in use. Additional functions such as spitting, which may be required prior to the beginning of a printing operation, may also be performed at the service station. The wiping function is typically performed by moving a wiper across each nozzle to remove excess ink remaining on the nozzles. The capping function is performed by sealing the printhead nozzles, for example, by sealing the nozzles through a suction cup. The capping function prevents evaporation, drying, or contamination of the ink at the nozzles. Having a separate mechanism, such as the service station, for performing the capping and wiping functions adds significant extra cost and complexity to the overall product.

### SUMMARY OF THE INVENTION

One embodiment of the invention provides a printhead assembly comprising a printhead body having at least one nozzle opening; a shutter member; and an actuator for moving the shutter member between an open position to expose the nozzle opening and a closed position to conceal the nozzle opening.

The shutter member may be adapted to wipe excess ink from the nozzle opening when the shutter member is moved from the open position to the closed position.

The shutter member may be adapted to seal the nozzle opening when the shutter member is in the closed position.

The shutter member may be a sheet, the sheet being in sliding engagement with the printhead body and having at least one shutter opening, the nozzle opening being exposed through the shutter opening when the shutter is in the open position.

The shutter opening may be elongated to expose a plurality of nozzle openings when said shutter member is in said open position.

The shutter member may comprise a metal material. Alternatively, the shutter member may comprise a polymer material.

The actuator may comprise a motor. In another embodiment, the actuator comprises at least one spring, the spring biasing the shutter member to one of the open position or the closed position; and a catch connected to the shutter member, the catch causing the shutter member to move against the spring into the other of the open position or the closed position when the catch engages a portion of a printer chassis.

In another embodiment, the shutter member is a blade, the blade being pivotably mounted upon the printhead body and being adapted to pivot between the open position and the closed position.

Another embodiment of the invention provides a printhead assembly comprising means for depositing an ink upon a printing medium; shutter means for selectively exposing and concealing the depositing means; and means for actuating the shutter means, the actuating means moving the shutter means between an open position and a closed position, wherein the shutter means is adapted to expose the depositing means when the shutter means is in the open position and to conceal the depositing means when the shutter means is in the closed position.

The shutter means may be adapted to wipe excess ink from the depositing means when the shutter means is moved from the open position to the closed position.

The shutter means may be adapted to seal the depositing means when the shutter means is in the closed position.

### BRIEF DESCRIPTION OF THE DRAWINGS

In the following, the invention will be explained in further detail with reference to the drawings, in which:

FIG. 1A is a schematic diagram of one embodiment of a printhead system with an integrated wiping and capping function;

FIG. 1B is a schematic diagram of a second embodiment of a printhead system with an integrated wiping and capping function;

FIG. 2A is a schematic diagram of another embodiment of a printhead system with an integrated wiping and capping function with a shutter in the closed position; and

FIG. 2B is a schematic diagram of the printhead system of FIG. 2b with the shutter in the open position.

### DESCRIPTION OF CERTAIN EMBODIMENTS OF THE INVENTION

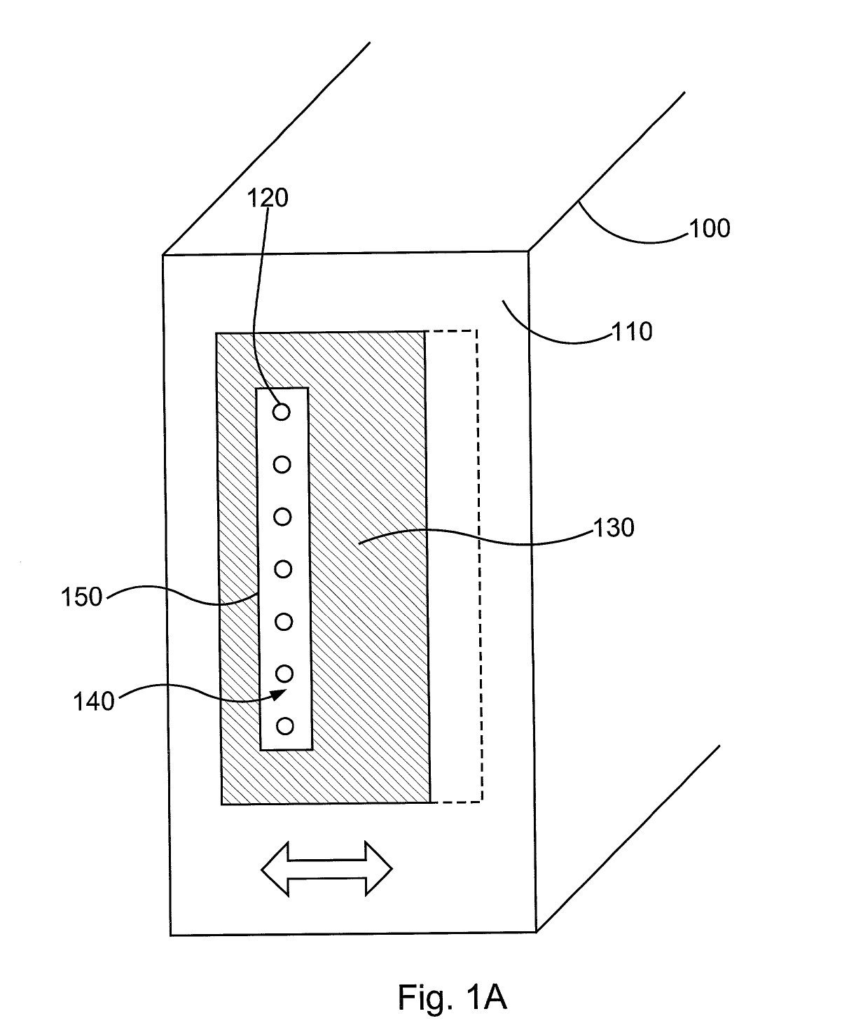

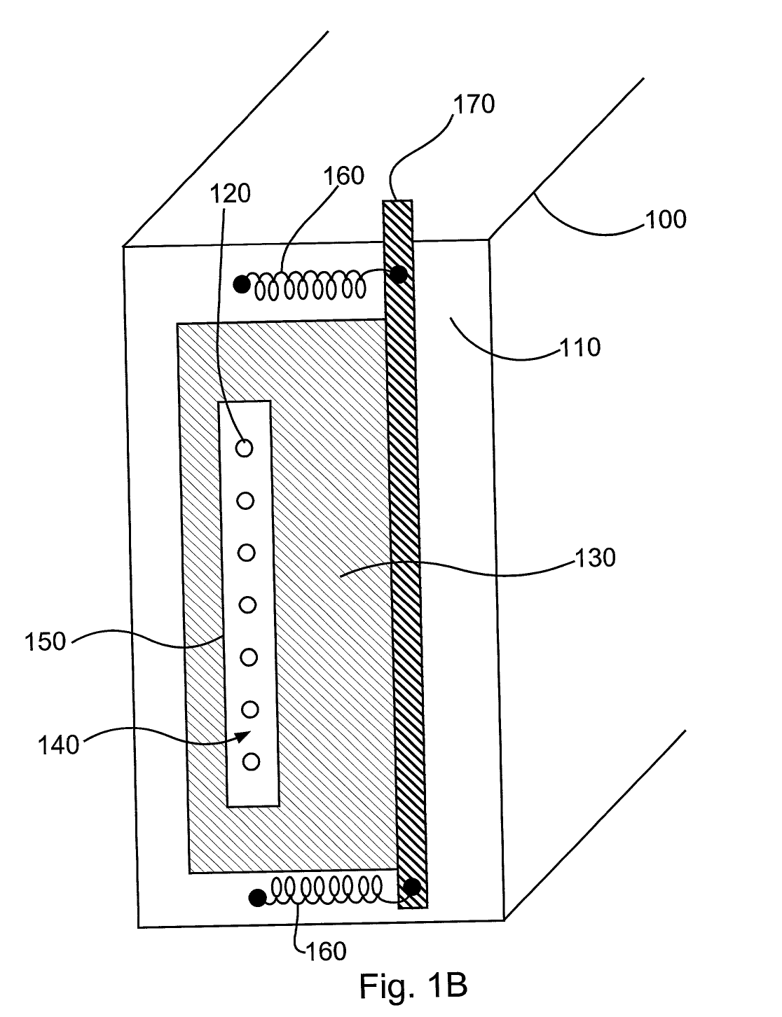

FIG. 1A illustrates a first embodiment of a printhead system according to the invention. The printhead system has a printhead body 100 that may be a conventional printhead. The printhead body 100 has a printing face 110 with a plurality of nozzles 120. FIG. 1 illustrates a printing face 110 with six nozzles 120. However, a printing face may have any practical number of nozzles. The nozzles 120 may be flush with the surface of the printing face 110 or may protrude from, or be disposed in, one or more lands that extend above the surface of the printing face 110.

A shutter 130 is provided on the printing face 110, and one or more portions thereof are in, or may be moved into, sliding engagement with the printing face 110 and/or the nozzles 120. As noted by the arrows, the printing face 110 in this example embodiment is adapted to move in either direction along an axis that is substantially perpendicular to the axis aligning the plurality of nozzles 120. The shutter 130 is provided with a shutter opening 140 to expose the nozzles 120.

In another embodiment, the single opening 140 may be replaced with a series of openings, each opening corresponding to a particular nozzle. In further embodiments, each opening may correspond to two or more nozzles.

Although FIG. 1A illustrates a printhead face 110 having a single row of nozzles 120, the shutter 130 and the shutter opening 140 may be sized to conceal and expose, respectively, a plurality of rows of nozzles as well.

The shutter opening 140 is sized to fully expose the nozzles 120 on the printing face. The shutter 130 may be made of any selected material such as, for example, a metal or one of any number of polymers. The sliding of the shutter 130 may be accomplished through a variety of actuation mechanisms. For example, a motor may be provided for causing the shutter 130 to move between one position and another position. For this purpose, the motor may be a small, silicon-based micro-motor, for example.

Alternatively, a mechanical system may be provided for actuation of the sliding shutter 130. One such mechanical system is illustrated in FIG. 1B. In this embodiment, springs 160 bias the shutter 130 towards one position, e.g., an open position in FIG. 1B. One end of the springs 160 is connected to the printhead body 100, while the other end is connected to a portion of the shutter 130 (shown in FIG. 1B by way of example, but not by way of limitation, as a catch 170). The shutter is provided with the catch 170 extending beyond the printing face 110 of the printhead body 100. When the printhead is moved to a non-printing position, a portion of the printer chassis (not shown) engages the catch 170 and urges the shutter against the force of the springs 160, causing the shutter 130 to move to a different position, e.g., a closed position in this embodiment.

Other actuation mechanisms, including mechanical, electrical, magnetic or other, are also within the scope of this invention.

Referring now to FIGS. 1A and 1B, during a printing operation, the shutter 130 is maintained in a position (“open position”) such that the shutter opening 140 exposes the nozzles 120 on the printing face 110. Thus, the nozzles 120 are exposed and are able to deposit ink on a printing medium such as paper. When no printing operation is being performed or when the printhead is in a maintenance mode, the shutter 130 is actuated to move into a position (“closed position”) such that the nozzles 120 are concealed by the shutter 130 and are not exposed. In this position, the shutter 130 may completely seal the nozzles 120 from the outside environment. During the movement of the shutter, an edge 150 of the shutter opening 140 acts to wipe excess ink from the nozzles. Thus, once the shutter 130 moves to the closed position, the shutter 130 has performed a wiping function. Additionally, in the closed position, a portion of the shutter is in engagement with the nozzles to cap the nozzles 120. In this manner, no additional mechanism, such as a service station, is required. The capping and wiping functions are integrated into the printhead system itself.

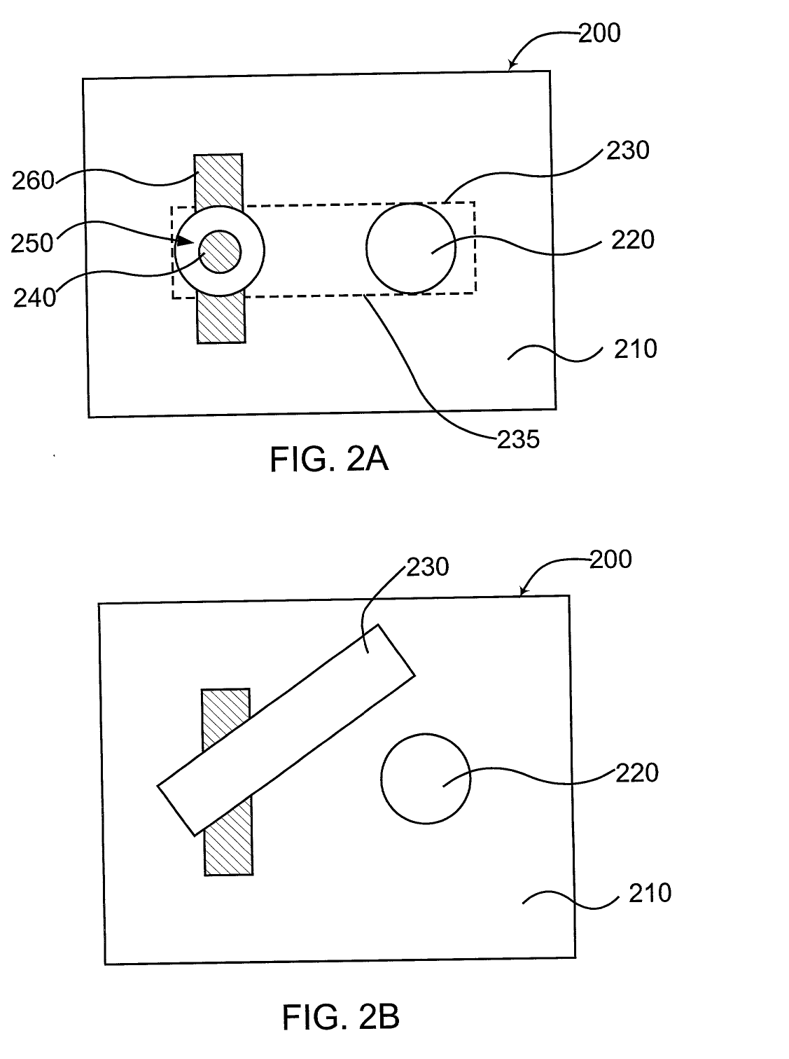

FIGS. 2A and 2B illustrate another embodiment of a printhead system according to the invention. As in the printhead system illustrated in FIGS. 1A and 1B, the printhead system of FIGS. 2A and 2B also comprises a printhead body 200 having a printing face 210. On the printing face 210, nozzle openings 220 are provided for depositing ink on a printing medium such as paper. The printhead system 200 illustrated in FIGS. 2A and 2B is shown as having a single nozzle opening 220. However, a printing face 210 may be provided with any practical number of nozzles. A shutter 230 (shown as a ghost in FIG. 2A) is pivotably mounted on the printing face 210. In this embodiment, the shutter 230 is in the form a blade which swings about a pivot point 240. The shutter 230 may be made of any material such as a metal or a polymer.

As in the embodiments illustrated in FIGS. 1A and 1B, the shutter 230 of the embodiment of FIGS. 2A and 2B may also be actuated using any of several mechanisms. In addition to the mechanical methods illustrated in FIG. 1B, for example, an electrical or a magnetic system may be employed as the actuating mechanism. In one embodiment, as illustrated in FIG. 2A, tiny silicon-based micro-motors 250 with charge magnets 260 may be utilized for this purpose. Such micro-motors are well known in the art.

FIG. 2A illustrates the shutter 230 in a closed position with the shutter 230 covering, and capping, the nozzle opening 220. FIG. 2B illustrates the shutter 230 in the open position in which the nozzle opening is allowed to print on a printing medium such as paper.

During a printing operation, the shutter 230 is maintained in the open position as illustrated in FIG. 2B. In this position, the shutter 230 does not interfere with the printing operation, as the nozzle opening 220 is completely exposed. When the printhead system is not performing a printing function or is in a maintenance mode, the shutter 230 is moved into the closed position as illustrated in FIG. 2A. As the shutter 230 is moved into the closed position, an edge 235 of the shutter blade 230 performs a wiping function on the nozzle opening and removes excess ink from the nozzle opening. Once the shutter 230 has moved into the closed position completely, the shutter performs the capping function and prevents drying or contamination of the ink.

Although FIGS. 2A and 2B illustrate the operation of the shutter 230 upon a single nozzle opening 220, multiple nozzle openings may also be wiped and capped using one or both ends of the single shutter 230. For example, the shutter 230 may be aligned such that, in its closed position, it caps a plurality of nozzle openings. In the open position, the shutter 230 could be pivoted sufficiently to expose each of the nozzle openings.

Thus, the invention provides a way of reducing cost, complexity and size of the overall product. An integrated wiping and capping function eliminates the need for a separate service station assembly. Additionally, the integrated wiping and capping function improves nozzle health maintenance.

While particular embodiments of the present invention have been disclosed, it is to be understood that various different modifications and combinations are possible and are contemplated within the true spirit and scope of the appended claims. There is no intention, therefore, of limitations to the exact abstract or disclosure herein presented.

What is claimed is:

1. A printhead assembly, comprising:
a printhead body having at least one nozzle opening;
a shutter member; and
an actuator for moving said shutter member between an open position to expose said nozzle opening and a closed position to conceal said nozzle opening.

2. The printhead assembly according to claim 1, wherein said shutter member is adapted to wipe excess ink from said nozzle opening when said shutter member is moved from said open position to said closed position.

3. The printhead assembly according to claim 1, wherein said shutter member is adapted to seal said nozzle opening when said shutter member is in said closed position.

4. The printhead assembly according to claim 1, wherein said shutter member is a sheet, said sheet being in sliding engagement with said printhead body and having at least one shutter opening, said nozzle opening being exposed through said shutter opening when said shutter is in said open position.

5. The printhead assembly according to claim 4, wherein said shutter opening is elongated to expose a plurality of nozzle openings when said shutter member is in said open position.

6. The printhead assembly according to claim 1, wherein said shutter member comprises a metal material.

7. The printhead assembly according to claim 1, wherein said shutter member comprises a polymer material.

8. The printhead assembly according to claim 1, wherein said actuator comprises a motor.

9. The printhead assembly according to claim 1, wherein said actuator comprises:
at least one spring, said spring biasing said shutter member to one of said open position or said closed position; and
a catch connected to said shutter member, said catch causing said shutter member to move against said spring into the other of said open position or said closed position when said catch engages a portion of a printer chassis.

10. The printhead assembly according to claim 1, wherein said shutter member is a blade, said blade being pivotably mounted upon said printhead body and being adapted to pivot between said open position and said closed position.

11. A printhead assembly, comprising:
means for depositing an ink upon a printing medium;
shutter means for selectively exposing and concealing said depositing means; and
means for actuating said shutter means, said actuating means moving said shutter means between an open position and a closed position,
wherein said shutter means is adapted to expose said depositing means when said shutter means is in said open position and to conceal said depositing means when said shutter means is in said closed position.

12. The printhead assembly according to claim 11, wherein said shutter means is adapted to wipe excess ink from said depositing means when said shutter means is moved from said open position to said closed position.

13. The printhead assembly according to claim 11, wherein said shutter means is adapted to seal said depositing means when said shutter means is in said closed position.
